(19) United States
(12) Patent Application Publication
(10) Pub. No.: US 2026/0029946 A1
(43) Pub. Date: Jan. 29, 2026

(54) VOLTAGE MONITORING BY A MEMORY SYSTEM

(71) Applicant: Micron Technology, Inc., Boise, ID (US)

(72) Inventors: Liang Yu, Boise, ID (US); Jonathan S. Parry, Boise, ID (US); Deping He, Boise, ID (US)

(21) Appl. No.: 19/260,135

(22) Filed: Jul. 3, 2025

Related U.S. Application Data
(60) Provisional application No. 63/674,688, filed on Jul. 23, 2024.

(51) Int. Cl. G06F 3/06

(52) U.S. Cl. CPC G06F 3/0653; G06F 3/0604; G06F 3/0679

(57) ABSTRACT

Methods, systems, and devices for voltage monitoring by a memory system are described. An application specific integrated circuit (ASIC) may be configured to provide feedback to one or more controllers of a memory system indicating whether a current sensed from an alternating current (AC) voltage source satisfies a threshold. The ASIC may output a flag in response to the current sensed by the ASIC satisfying the threshold, and the memory system may perform power management operations by adjusting operating parameters in response to the flag. The ASIC may be configured to generate token information that estimates a total current budget for the memory system in accordance with a power consumption at components of the memory system (e.g., AC components, direct current (DC) components, open NAND flash interface (ONFI) components), and the memory system may perform power management operations in response to the total current budget satisfying a threshold.

### CROSS REFERENCE

The present application for patent claims priority to U.S. Patent Application No. 63/674,688 by Yu et al., entitled “VOLTAGE MONITORING BY A MEMORY SYSTEM,” filed Jul. 23, 2024, which is assigned to the assignee hereof, and which is expressly incorporated by reference in its entirety herein.

### TECHNICAL FIELD

The following relates to one or more systems for memory, including voltage monitoring by a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports voltage monitoring by a memory system in accordance with examples as disclosed herein.

FIG. 2 shows an example of an architecture that supports voltage monitoring by a memory system in accordance with examples as disclosed herein.

FIG. 3 shows an example of a process that supports voltage monitoring by a memory system in accordance with examples as disclosed herein.

FIG. 4 shows a block diagram of a memory system that supports voltage monitoring by a memory system in accordance with examples as disclosed herein.

FIG. 5 shows a flowchart illustrating a method or methods that support voltage monitoring by a memory system in accordance with examples as disclosed herein.

### DETAILED DESCRIPTION

Some systems may include multiple electronic components that are each coupled with a power source. For example, a memory system, such as a not-and (NAND) system or a managed NAND (MNAND) system, may include one or more memory dies and, in some examples, an application-specific integrated circuit (ASIC), among other components that use power from a power source to perform one or more operations. To support managing power consumption (e.g., peak power consumption) from the power source, one or more controllers of the memory system may perform power management operations in response to detecting different patterns of operations at the memory system (e.g., random reads, random writes, sequential reads, sequential writes, etc.). For example, each type of operation may be associated with a respective power profile (e.g., which may be determined in accordance with power measurements during a test procedure or determined prior to deployment of the memory system). However, performing power management using power profiles in accordance with predefined patterns of operation may result in inaccuracies for performing power management or excessive latency associated with determining the power consumption from the power source.

In accordance with the examples described herein, an ASIC may be configured to provide direct feedback to the one or more controllers of the memory system indicating whether a current sensed from an alternating current (AC) voltage source (e.g., and supplied to one or more components of the memory system) satisfies a threshold. As described herein, an AC voltage source may refer to a voltage source that supplies DC voltage that is sensed by the memory system 110 as an AC current in accordance with a load coupled with the voltage source (e.g., a clock). The ASIC may output a flag in response to the current (sensed by the ASIC) satisfying a threshold, and the memory system may perform power management operations by adjusting one or more operating parameters in response to the flag. Additionally, or alternatively, the ASIC may be configured to generate information (e.g., tokens) associated with estimations of a total current budget for the memory system in accordance with a power consumption at various components of the memory system (e.g., AC components, direct current (DC) components, open NAND flash interface (ONFI) components, etc.), and the memory system may perform power management operations in response to the total current budget satisfying a threshold. Such operations may result in power management operations being performed with increased accuracy, while reducing or otherwise eliminating latency that would occur due to determining a power consumption from the power source.

In addition to applicability in memory systems as described herein, techniques for voltage monitoring by a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving power management techniques and reducing a peak power budget of a memory system, which may decrease processing or latency times, improve response times, or otherwise improve user experience, among other benefits.

Features of the disclosure are illustrated and described in the context of systems, devices, and circuits. Features of the disclosure are further illustrated and described in the context of architectures, processes, block diagrams, and flowcharts.

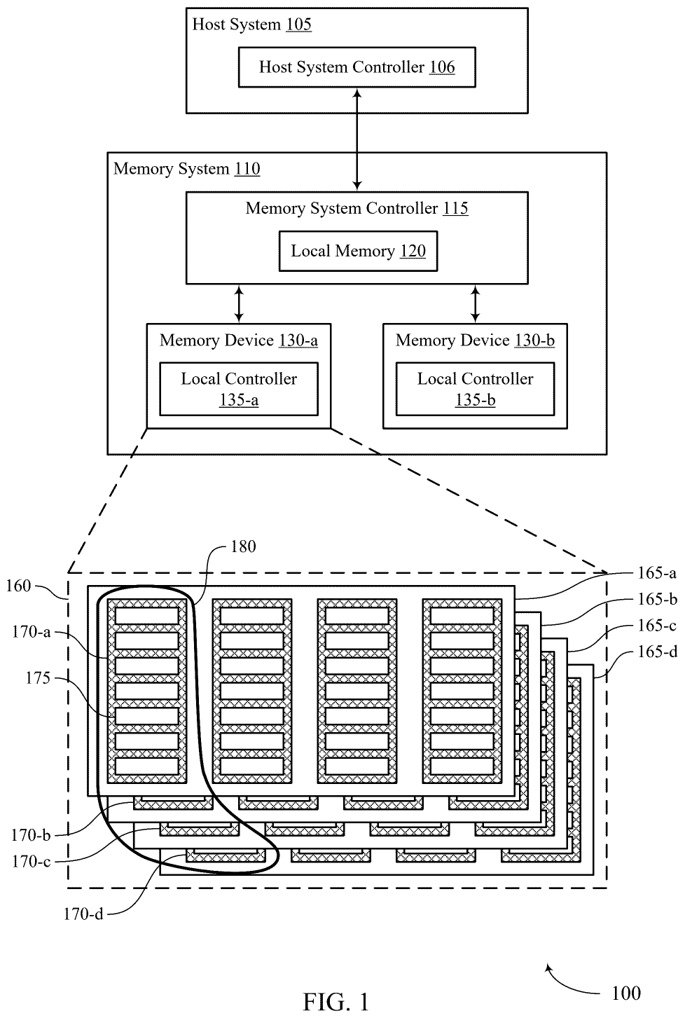

FIG. 1 shows an example of a system 100 that supports voltage monitoring by a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an ONFI, and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an ASIC, a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a MNAND device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an ASIC, a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a MNAND system.

The memory system 110 may include multiple electronic components that are each coupled with a power source. For example, the memory system 110, which may be a NAND system or a MNAND system, may include one or more memory dies 160 and, in some examples, an ASIC, which may be an example of or otherwise associated with a memory system controller 115, among other components that use power from a power source to perform one or more operations. To support managing power consumption (e.g., peak power consumption) from the power source, one or more controllers of the memory system may perform power management operations (e.g., by adjusting a clock rate, for example) in response to detecting different patterns of operations at the memory system 110 (e.g., random reads, random writes, sequential reads, sequential writes, etc.). For example, the type of operation may be associated with a respective power profile (e.g., which may be in accordance with power measurements during a test procedure, or may be determined prior to deployment of the memory system 110). However, performing power management using power profiles in accordance with the predefined patterns of operation may result in inaccuracies for performing power management or excessive latency associated with determining the power consumption from the power source.

In accordance with the examples described herein, an ASIC may be configured to provide direct feedback to the one or more controllers of the memory system indicating whether a current sensed from an AC voltage source (e.g., and supplied to one or more components of the memory system 110) satisfies a threshold. As described herein, an AC voltage source may refer to a voltage source that supplies DC voltage that is sensed by the memory system 110 as an AC current in accordance with a load coupled with the voltage source (e.g., a clock). The ASIC may output a flag in response to the current (sensed by the ASIC) satisfying a threshold, and the memory system 110 may perform power management by adjusting one or more operating parameters in response to the flag. Additionally, or alternatively, the ASIC may be configured to generate information (e.g., tokens) associated with estimations of a total current budget for the memory system 110 in accordance with a power consumption at various components of the memory system 110 (e.g., AC components, DC components, ONFI components, etc.), and the memory system 110 may perform power management operations in response to the total current budget satisfying a threshold. Such operations may result in power management operations being performed with increased accuracy, while reducing or otherwise eliminating latency that would occur due to determining a power consumption from the power source.

The system 100 may include any quantity of non-transitory computer readable media that support voltage monitoring by a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

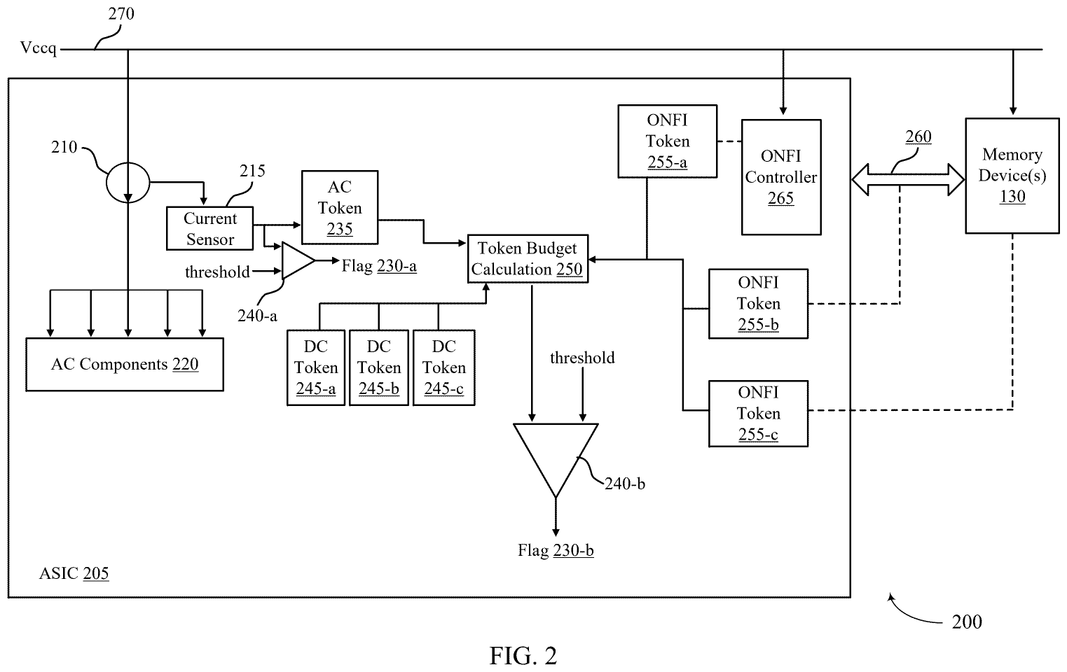

FIG. 2 shows an example of an architecture 200 that supports voltage monitoring by a memory system in accordance with examples as disclosed herein. The architecture may implement or may be implemented by aspects of the system 100. For example, the architecture 200 may include an ASIC 205, which may be an example of or otherwise associated with a memory system controller 115 as described with reference to FIG. 1. In some examples, the ASIC 205 may be configured to perform specific applications or tasks for a memory system 110. For example, the ASIC may communicate with (e.g., via an ONFI bus 260) or otherwise manage communications (e.g., manage data) for the memory devices 130 of the memory system 110.

The ASIC 205 may receive power from a voltage source 270 (e.g., Vccq). In some cases, the voltage source 270 may be a common voltage source that supplies power to the ASIC 205 (e.g., to AC components 220 of the ASIC 205), an ONFI controller 265, and the memory devices 130, among other components. In some examples (e.g., due to the voltage source being shared by multiple components of a memory system), firmware or one or more controllers of the memory system may be unaware of the amount of power being consumed by the various components. The power management controller may be associated with firmware of a memory system controller 115 (or may refer to the memory system controller 115), may be a host system controller 106, or may be a power management integrated circuit (PMIC).

In accordance with examples described herein, the ASIC 205 may be configured to measure a current (e.g., an AC current) that is supplied to the ASIC 205 and may output a flag 230-a (e.g., for triggering power management operations) in response to whether the measured current satisfies a threshold. For example, the ASIC 205 may include a current mirror 210 (e.g., a power management unit (PMU) current mirror). The current mirror 210 may regulate a current from the voltage source 270 (e.g., such that the current remains constant irrespective of a load from the AC components 220). In some examples, the current mirror 210 may supply current (e.g., from the voltage source 270) to AC components 220 of the ASIC 205. The AC components may include a CPU, a low density parity check (LDPC) code, a channel, a NAND flash controller (NFC), a data path scheduler (DPS), or a clock management circuit, among other components.

A current sensor 215 may receive (e.g., measure, sense) a current (e.g., an AC current) from the current mirror 210. The current obtained by the current sensor 215 may be input to a comparator 240-a to determine whether the current satisfies a threshold. In some examples, the threshold may be static over a life cycle of the memory system, or the threshold may be adjusted (e.g., dynamically, such as via indication from the host system 105 or memory system controller 115). If the current satisfies the threshold, the ASIC may output a flag 230-a. For example, the ASIC may output the flag 230-a to the power management controller, which may adjust one or more operating parameters or power profiles associated with the memory system in response to receiving the flag.

In some examples, the ASIC 205 may generate an AC token 235 (e.g., a power token) in accordance with the current obtained by the current sensor 215. The ASIC 205 may input the AC token 235 to a token budget calculation unit 250, where the ASIC 205 may combine current information (e.g., tokens) from multiple sources to determine a total power consumption (e.g., a peak power budget) for the memory system. For example, the ASIC 205 may estimate a power consumption by DC components (e.g., using one or more DC tokens 245) and by components associated with an ONFI bus 260 (e.g., using one or more ONFI tokens 255). One or more of the AC token 235, the DC tokens 245, and the ONFI tokens 255 may each include or may otherwise be represented by one or more bits (e.g., a set of digital bits). For example, current information may be encoded in the one or more bits.

To estimate the current information (e.g., and corresponding power consumption) associated with DC components, the ASIC 205 may generate a DC token 245-a, a DC token 245-b, and a DC token 245-c, among other potential DC tokens 245. The DC tokens 245 may be in accordance with current information associated with a DC voltage source (not shown) which may power one or more components of the memory system. The DC token 245-a may be indicative of current supplied to (e.g., or power consumed by) a M-PHY physical layer. The DC token 245-a may be estimated in accordance with a quantity of M-PHY lanes or high speed gear information associated with the M-PHY layer. The DC token 245-b may be indicative of current supplied to (e.g., or power consumed by) one or more logical gates. The ASIC 205 may include a temperature sensor and the DC token 245-b may be estimated in accordance with a temperature measurement (e.g., temperature reading) from the temperature sensor. The DC token 245-c may be indicative of current supplied to (e.g., or power consumed by) a phase-locked loop. The phase-locked loop may be associated with the ONFI bus 260. The DC token 245-c may be estimated in accordance with a clock frequency that the memory system is currently operating at.

To estimate the current information (e.g., and corresponding power consumption) associated with the ONFI components, the ASIC 205 may generate an ONFI token 255-a, an ONFI token 255-b, and an ONFI token 255-c, among other potential ONFI tokens 255, in accordance with values from one or more look up tables, which may be loaded onto the ASIC 205 (e.g., prior to deployment). The ONFI token 255-a may be indicative of current supplied to (e.g., or power consumed by) an ONFI controller 265, which may configure one or more parameters or perform one or more operations associated with the ONFI bus 260. The ONFI token 255-a may be estimated in accordance with a value from a look up table, and the value may be in accordance with an operating frequency (e.g., a speed) of the ONFI bus 260, a quantity of active or otherwise utilized channels of the ONFI bus 260, and/or an indication of whether the ONFI bus 260 is associated with an ongoing read or a write operation.

The ONFI token 255-b may be indicative of a current supplied to (e.g., or power consumed by) the ONFI bus 260 (e.g., to channels of the ONFI bus 260). The ONFI token 255-b may be estimated in accordance with a value from a look up table, and the value may be in accordance with an operating frequency (e.g., a speed) of the ONFI bus 260, a quantity of channels of the ONFI bus 260, and/or an indication of whether the ONFI bus 260 is operating in a low or otherwise reduced voltage mode (e.g., is using a voltage less than the voltage source 270, is using a subset of the voltage source 270). The ONFI token 255-c may be indicative of a current supplied to (e.g., or power consumed by) memory devices 130. The memory devices 130 (e.g., NAND arrays, dies 160) may be coupled with the ASIC 205 via the ONFI bus 260. The ONFI token 255-b may be estimated in accordance with a value from a look up table, and the value may be in accordance with an operating frequency (e.g., a speed) of the ONFI bus 260, a quantity of channels of the ONFI bus 260, and/or an indication of whether a voltage source internal to the memory devices is enabled or disabled.

The token budget calculation unit 250 may combine values from one or more of the AC token 235, the DC tokens 245, and the ONFI tokens 255. For example, the token budget calculation unit 250 may compute a sum of the multiple token values (e.g., using an adder of the ASIC 205). Accordingly, the token budget calculation unit 250 may calculate a total current budget associated with the memory system (e.g., the memory system 110). The total current budget may indicate a maximum current used by the memory system. The ASIC 205 may input the total current budget calculated by the token budget calculation unit 250 to a comparator 240-b, which may compare the total current budget to a threshold (e.g., 1200 mA, for example). In some examples, the threshold may be static over a life cycle of the memory system, or the threshold may be adjusted (e.g., dynamically, such as via indication from the host system 105 or memory system controller 115). If the total current budget satisfies the threshold, the ASIC may output a flag 230-b. For example, the ASIC may output the flag 230-b to a power management controller, which may adjust one or more operating parameters or power profiles associated with the memory system in response to receiving the flag.

In accordance with these and other examples, the ASIC 205 may be configured to provide feedback indicating current information to a power management controller in accordance with configurations and/or parameters of a memory system while the memory system is in deployment. That is, the ASIC 205 may indicate the current information on-the fly, and/or at various times during operation of the memory system (e.g., periodically, in accordance with one or more triggering events). By indicating the current information as direct feedback to the power management controller, the ASIC 205 may support increased accuracy and flexibility of power management and reduced latency, resulting in improved system performance.

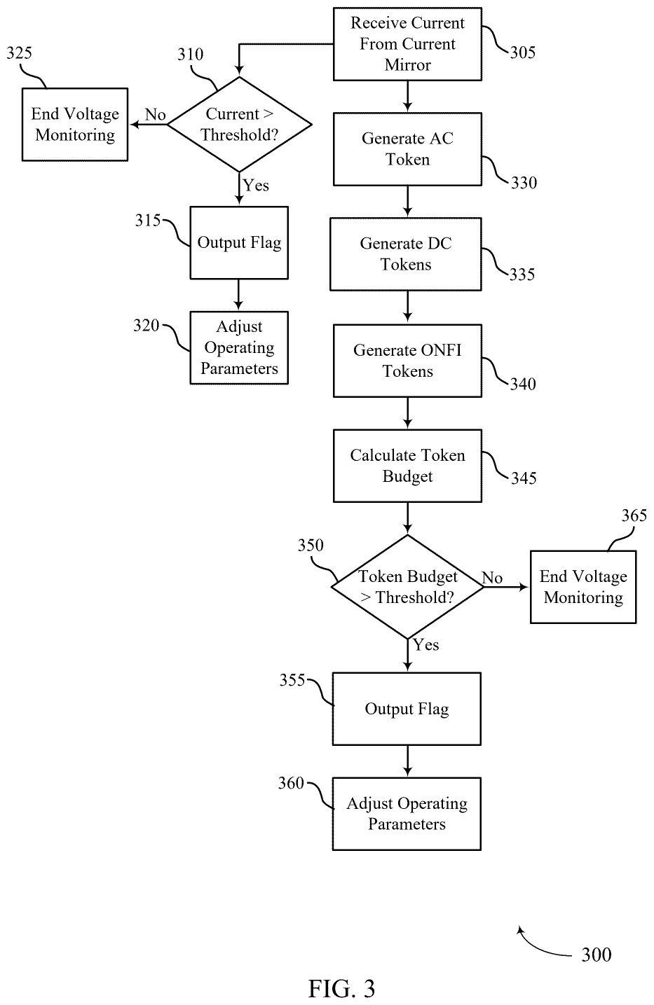

FIG. 3 shows an example of a process 300 that supports voltage monitoring by a memory system in accordance with examples as disclosed herein. The process 300 may implement aspects or operations of a system, which may be an example of a system 100, as described with reference to FIG. 1. For example, the process 300 may be implemented by a memory system, which may be an example of a memory system 110. In some cases, the process 300 may be facilitated by a memory system controller, which may be an example of a memory system controller 115 or an ASIC 205. The process 300 may illustrate techniques for a voltage monitoring procedure at a memory device, which may support increased accuracy and efficiency of power management procedures at the memory system, thereby increasing system performance.

In the following description of the process 300, the methods, techniques, processes, and operations may be performed in different orders or at different times. Further, some operations may be left out of the process 300, or other operations may be added to the process 300. Aspects of the process 300 may be implemented by one or more controllers, among other components. Additionally, or alternatively, aspects of the process 300 may be implemented as instructions stored in one or more memories (e.g., volatile memory, non-volatile memory). For example, the instructions, when executed by one or more controllers (e.g., the memory system controller 115), the ASIC 205 may cause the one or more controllers (or a device or a system) to perform the operations of the process 300.

At 305, a current may be received. In some instances, the current may be received from a current mirror that is coupled with an AC voltage source. For example, a memory system (e.g., a memory system controller 115, an ASIC 205) may receive (e.g., measure, sense) the current using a current sensor. The AC voltage source may power one or more first components (e.g., AC components 220) of the memory system.

At 310, it may be determined whether the current from the current mirror satisfies a threshold value. For example, the memory system (e.g., a memory system controller 115, an ASIC 205) may determine whether the current satisfies the threshold value. If, at 310, it is determined that the current does not satisfy the threshold, the process 300 may proceed to 325 and the voltage monitoring procedure may be stopped. If, at 310, it is determined that the current satisfies the threshold value, the process 300 may proceed to 315 where a first flag (e.g., an alert) may be output. For example, the memory system (e.g., the memory system controller 115, the ASIC 205) may output the first flag to a power management controller.

At 320, one or more operating parameters of the memory system may be adjusted in response to the determination that the current received by the current sensor satisfies the threshold value, in response to outputting the first flag, or both. For example, a power management controller may adjust a rate of a clock associated with the memory system, a pattern of the clock, or both. The power management controller may apply a delay (e.g., stagger) to one or more commands (e.g., ONFI commands) received by the memory system, transmitted by the memory system, or both. Additionally, or alternatively, the power management controller may generate (e.g., or adjust) power profiles associated with the memory system (e.g., in accordance with one or more sets of operating parameters associated with the memory system). The power profiles may be adjusted with respect to clock frequency values, voltage values, or both. For example, the power profiles may adjust the clock frequency and/or the voltage supplied to the memory system in accordance with a power profile that is configured for the memory system.

At 330, an AC token may be generated. For example, the memory system (e.g., a memory system controller 115, an ASIC 205) may generate the AC token (e.g., the AC token 235) in accordance with the current received by the current sensor at 305. At 335, one or more DC tokens may be generated. For example, the memory system (e.g., a memory system controller 115, an ASIC 205) may generate the DC tokens (e.g., the DC token 245-a, the DC token 245-b, the DC token 245-c) in accordance with current information associated with a DC voltage source that powers one or more second components of the memory system (e.g., different than the one or more first components).

At 340, one or more ONFI tokens may be generated. For example, the memory system (e.g., the memory system controller 115, the ASIC 205) may generate the ONFI tokens (e.g., the ONFI token 255-a, the ONFI token 255-b, the ONFI token 255-c) in accordance with current information associated with an interface (e.g., an ONFI bus 260) of the memory system. In some examples, one or more of the operations of 330, 335, and 340 may be performed in parallel (e.g., simultaneously). Additionally, or alternatively, one or more of the operations of 330, 335, and 340 may be performed in sequence.

At 345, a token budget (e.g., a peak power budget) of the memory system may be calculated. For example, the memory system (e.g., a memory system controller 115, an ASIC 205) may calculate the token budget in accordance with a combination (e.g., a sum) of one or more of the AC token (e.g., generated at 330), the DC tokens (e.g., generated at 335), and the ONFI tokens (e.g., generated at 345). At 350, it may be determined whether one or more of the first token, the second token, and the third token satisfies a second threshold value. For example, the memory system (e.g., the memory system controller 115, the ASIC 205) may determine whether the token budget calculated at 345 satisfies the second threshold value (e.g., 1200 mA).

If, at 350, one or more of the first token, the second token, and the third token (e.g., the total token budget, the peak power budget) does not satisfy the second threshold value, the process 300 may proceed to 365 and the voltage monitoring procedure may be stopped. In some examples, the voltage monitoring procedure may be restarted (e.g., repeated) according to a periodicity (e.g., 1 μs, 5 μs, 100 ns, 500 ns, etc.). In some cases, the periodicity may be indicated by a host system 105 (e.g., static configuration, dynamic configuration). For example, after 365, the voltage monitoring procedure may repeat the operations of 305 through 350 at a second time to obtain updated measurements and/or calculations and to perform ongoing power management. If, at 350, one or more of the first token, the second token, and the third token satisfies the second threshold value, the process 300 may proceed to 355 where a second flag (e.g., an alert) may be output. The second flag may be different than the first flag output at 315, or it may be the same flag. For example, the memory system (e.g., the memory system controller 115, the ASIC 205) may output the second flag to a power management controller.

At 360, one or more operating parameters of the memory system may be adjusted in response to the determination that one or more of the first token, the second token, and the second token satisfies the second threshold value, in response to outputting the second flag, or both. In some examples, adjusting the one or more operating parameters at 360 may be in accordance with one or both of the first flag and the second flag being output. For example, a power management controller may adjust a rate of a clock associated with the memory system, a pattern of the clock, or both. The power management controller may apply a delay (e.g., stagger) to one or more commands (e.g., ONFI commands) received by the memory system, transmitted by the memory system, or both. Additionally, or alternatively, the power management controller may generate (e.g., or adjust) power profiles associated with the memory system (e.g., in accordance with one or more sets of operating parameters associated with the memory system). The power profiles may be adjusted with respect to clock frequency values, voltage values, or both. For example, the power profiles may adjust the clock frequency and/or the voltage supplied to the memory system in accordance with a power profile that is configured for the memory system. By indicating the current information as direct feedback to the power management controller, the memory system described herein may support increased accuracy and flexibility of power management and reduced latency, resulting in improved system performance.

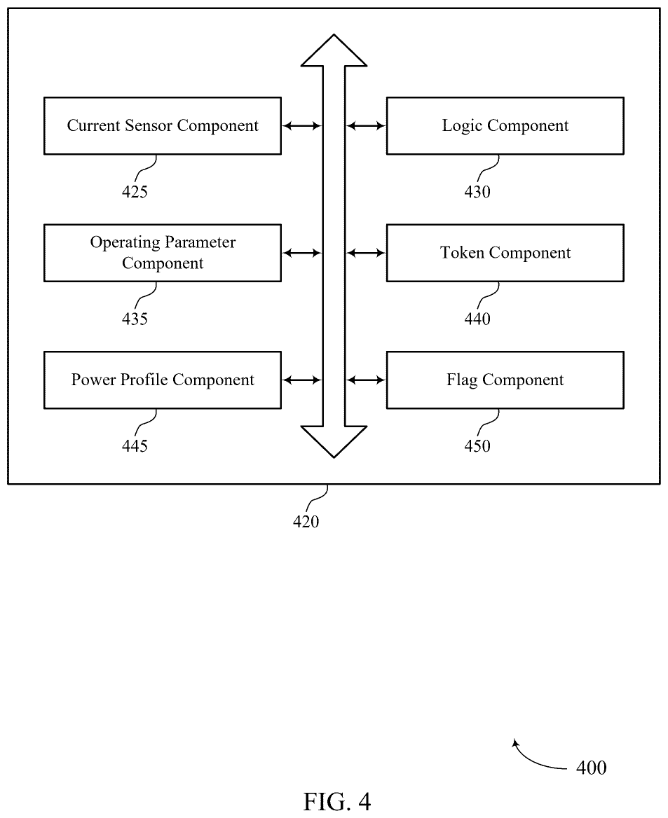

FIG. 4 shows a block diagram 400 of a memory system 420 that supports voltage monitoring by a memory system in accordance with examples as disclosed herein. The memory system 420 may be an example of aspects of a memory system 110 (e.g., a memory system controller 115) or an ASIC 205 as described with reference to FIGS. 1 through 3. The memory system 420, or various components thereof, may be an example of means for performing various aspects of voltage monitoring by a memory system as described herein. For example, the memory system 420 may include a current sensor component 425, a logic component 430, an operating parameter component 435, a token component 440, a power profile component 445, a flag component 450, or any combination thereof. Each of these components, or components of subcomponents thereof (e.g., one or more processors, one or more memories), may communicate, directly or indirectly, with one another (e.g., via one or more buses).

The current sensor component 425 may be configured as or otherwise support a means for receiving, by a current sensor, a current from a current mirror coupled with an AC voltage source, where the AC voltage source is associated with powering a set of components of the memory system. The logic component 430 may be configured as or otherwise support a means for determining whether the current received by the current sensor satisfies a threshold value. The operating parameter component 435 may be configured as or otherwise support a means for adjusting one or more operating parameters of the memory system in response to determining that the current received by the current sensor satisfies the threshold value.

In some examples, the token component 440 may be configured as or otherwise support a means for generating a first token in accordance with first current information associated with a DC voltage source, where the DC voltage source is associated with powering a second set of components of the memory system. In some examples, the token component 440 may be configured as or otherwise support a means for generating a second token in accordance with second current information associated with an interface of the memory system, where adjusting the one or more operating parameters associated with the memory system is in response to generating the first token and the second token.

In some examples, the token component 440 may be configured as or otherwise support a means for generating a third token in accordance with the current received by the current sensor. In some examples, the logic component 430 may be configured as or otherwise support a means for determining whether one or more of the first token, the second token, and the third token satisfies a second threshold value, where adjusting the one or more operating parameters associated with the memory system is in response to determining that one or more of the first token, the second token, and the third token satisfies the second threshold value.

In some examples, the first token is associated with an M-PHY interface powered by the DC voltage source, one or more logic gates powered by the DC voltage source, and a phase locked loop powered by the DC voltage source.

In some examples, the second token is associated with one or more controllers associated with the interface, one or more channels associated with the interface, and the one or more memory devices associated with the interface.

In some examples, to support adjusting the one or more operating parameters, the operating parameter component 435 may be configured as or otherwise support a means for adjusting a rate of a clock associated with the memory system, a pattern of the clock associated with the memory system, or both, in response to determining that the current received by the current sensor satisfies the threshold value.

In some examples, the power profile component 445 may be configured as or otherwise support a means for generating one or more power profiles associated with the memory system in response to determining that the current received by the current sensor satisfies the threshold value and in response to adjusting the one or more operating parameters.

In some examples, to support adjusting the one or more operating parameters, the operating parameter component 435 may be configured as or otherwise support a means for applying a delay to one or more commands received by the memory system in response to determining that the current received by the current sensor satisfies the threshold value.

In some examples, the flag component 450 may be configured as or otherwise support a means for outputting a flag in response to determining that the current received by the current sensor satisfies the threshold value, where adjusting the one or more operating parameters is in response to outputting the flag.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

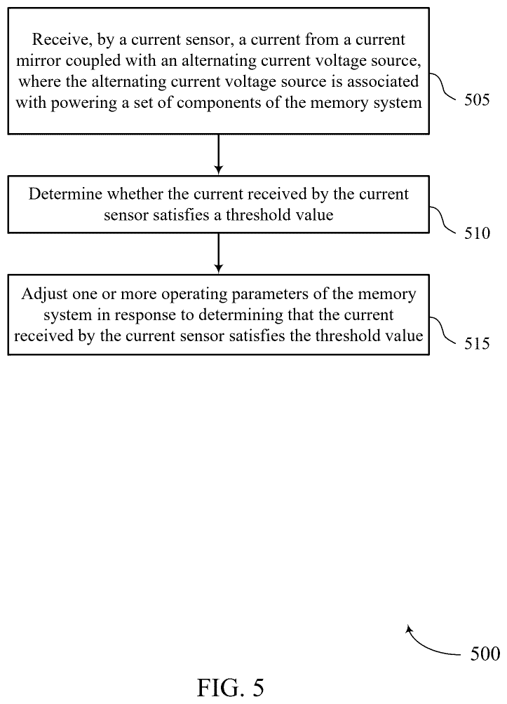

FIG. 5 shows a flowchart illustrating a method 500 that supports voltage monitoring by a memory system in accordance with examples as disclosed herein. The operations of method 500 may be implemented by a memory system or its components as described herein. For example, the operations of method 500 may be performed by a memory system 110 (e.g., a memory system controller 115) or an ASIC 205 as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, by a current sensor, a current from a current mirror coupled with an AC voltage source, where the AC voltage source is associated with powering a set of components of the memory system. In some examples, aspects of the operations of 505 may be performed by a current sensor component 425 as described with reference to FIG. 4.

At 510, the method may include determining whether the current received by the current sensor satisfies a threshold value. In some examples, aspects of the operations of 510 may be performed by a logic component 430 as described with reference to FIG. 4.

At 515, the method may include adjusting one or more operating parameters of the memory system in response to determining that the current received by the current sensor satisfies the threshold value. In some examples, aspects of the operations of 515 may be performed by an operating parameter component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, by a current sensor, a current from a current mirror coupled with an AC voltage source, where the AC voltage source is associated with powering a set of components of the memory system; determining whether the current received by the current sensor satisfies a threshold value; and adjusting one or more operating parameters of the memory system in response to determining that the current received by the current sensor satisfies the threshold value.

Aspect 2: The method, apparatus, or non-transitory computer-readable medium of aspect 1, further including operations, features, circuitry, logic, means, or instructions, or any combination thereof for generating a first token in accordance with first current information associated with a DC voltage source, where the DC voltage source is associated with powering a second set of components of the memory system and generating a second token in accordance with second current information associated with an interface of the memory system, where adjusting the one or more operating parameters associated with the memory system is in response to generating the first token and the second token.

Aspect 3: The method, apparatus, or non-transitory computer-readable medium of aspect 2, further including operations, features, circuitry, logic, means, or instructions, or any combination thereof for generating a third token in accordance with the current received by the current sensor and determining whether one or more of the first token, the second token, and the third token satisfies a second threshold value, where adjusting the one or more operating parameters associated with the memory system is in response to determining that one or more of the first token, the second token, and the third token satisfies the second threshold value.

Aspect 4: The method, apparatus, or non-transitory computer-readable medium of any of aspects 2 through 3, where the first token is associated with an M-PHY interface powered by the DC voltage source, one or more logic gates powered by the DC voltage source, and a phase locked loop powered by the DC voltage source.

Aspect 5: The method, apparatus, or non-transitory computer-readable medium of any of aspects 2 through 4, where the second token is associated with one or more controllers associated with the interface, one or more channels associated with the interface, and the one or more memory devices associated with the interface.

Aspect 6: The method, apparatus, or non-transitory computer-readable medium of any of aspects 1 through 5, where adjusting the one or more operating parameters includes operations, features, circuitry, logic, means, or instructions, or any combination thereof for adjusting a rate of a clock associated with the memory system, a pattern of the clock associated with the memory system, or both, in response to determining that the current received by the current sensor satisfies the threshold value.

Aspect 7: The method, apparatus, or non-transitory computer-readable medium of any of aspects 1 through 6, further including operations, features, circuitry, logic, means, or instructions, or any combination thereof for generating one or more power profiles associated with the memory system in response to determining that the current received by the current sensor satisfies the threshold value and in response to adjusting the one or more operating parameters.

Aspect 8: The method, apparatus, or non-transitory computer-readable medium of any of aspects 1 through 7, where adjusting the one or more operating parameters includes operations, features, circuitry, logic, means, or instructions, or any combination thereof for applying a delay to one or more commands received by the memory system in response to determining that the current received by the current sensor satisfies the threshold value.

Aspect 9: The method, apparatus, or non-transitory computer-readable medium of any of aspects 1 through 8, further including operations, features, circuitry, logic, means, or instructions, or any combination thereof for outputting a flag in response to determining that the current received by the current sensor satisfies the threshold value, where adjusting the one or more operating parameters is in response to outputting the flag.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 10: An ASIC, including: an AC voltage source associated with powering one or more components of the ASIC; a current mirror coupled with the AC voltage source; a current sensor configured to receive a current from the current mirror; and logic coupled with the current sensor and configured to: determine whether the current received by the current sensor satisfies a threshold value; and adjust one or more operating parameters associated with the ASIC in response to determining that the current received by the current sensor satisfies the threshold value.

Aspect 11: The ASIC of aspect 10, further including: a DC voltage source associated with powering one or more second components of the ASIC; and an interface, where the logic is further configured to: generate a first token in accordance with first current information associated with the DC voltage source; and generate a second token in accordance with second current information associated with the interface, where adjusting the one or more operating parameters associated with the ASIC is in response to generating the first token and the second token.

Aspect 12: The ASIC of aspect 11, where the logic is further configured to: generate a third token in accordance with the current received by the current sensor; and determine whether one or more of the first token, the second token, and the third token satisfies a second threshold value, where adjusting the one or more operating parameters associated with the ASIC is in response to determining that one or more of the first token, the second token, and the third token satisfies the second threshold value.

Aspect 13: The ASIC of any of aspects 11 through 12, where the first token is associated with an M-PHY interface powered by the DC voltage source, one or more logic gates powered by the DC voltage source, and a phase locked loop powered by the DC voltage source.

Aspect 14: The ASIC of any of aspects 11 through 13, where the second token is associated with one or more controllers associated with the interface, one or more channels associated with the interface, and one or more memory devices associated with the interface.

Aspect 15: The ASIC of any of aspects 10 through 14, where the logic is further configured to: adjust a rate of a clock associated with the ASIC, a pattern of the clock associated with the ASIC, or both, in response to determining that the current received by the current sensor satisfies the threshold value.

Aspect 16: The ASIC of any of aspects 10 through 15, where the logic is further configured to: generate one or more power profiles associated with the ASIC in response to determining whether the current received by the current sensor satisfies the threshold value and in response to adjusting the one or more operating parameters.

Aspect 17: The ASIC of any of aspects 10 through 16, where the logic is further configured to: apply a delay to one or more commands received by an interface of the ASIC in response to determining that the current received by the current sensor satisfies the threshold value.

Aspect 18: The ASIC of any of aspects 10 through 17, where the logic is further configured to: output a flag in response to determining that the current received by the current sensor satisfies the threshold value.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive, by a current sensor, a current from a current mirror coupled with an alternating current voltage source, wherein the alternating current voltage source is associated with powering a set of components of the memory system;
determine whether the current received by the current sensor satisfies a threshold value; and
adjust one or more operating parameters of the memory system in response to determining that the current received by the current sensor satisfies the threshold value.

2. The memory system of claim 1, wherein the processing circuitry is further configured to cause the memory system to:
generate a first token in accordance with first current information associated with a direct current voltage source, wherein the direct current voltage source is associated with powering a second set of components of the memory system; and
generate a second token in accordance with second current information associated with an interface of the memory system, wherein adjusting the one or more operating parameters associated with the memory system is in response to generating the first token and the second token.

3. The memory system of claim 2, wherein the processing circuitry is further configured to cause the memory system to:
generate a third token in accordance with the current received by the current sensor; and
determine whether one or more of the first token, the second token, and the third token satisfies a second threshold value, wherein adjusting the one or more operating parameters associated with the memory system is in response to determining that one or more of the first token, the second token, and the third token satisfies the second threshold value.

4. The memory system of claim 2, wherein the first token is associated with an M-PHY interface powered by the direct current voltage source, one or more logic gates powered by the direct current voltage source, and a phase locked loop powered by the direct current voltage source.

5. The memory system of claim 2, wherein the second token is associated with one or more controllers associated with the interface, one or more channels associated with the interface, and the one or more memory devices associated with the interface.

6. The memory system of claim 1, wherein adjusting the one or more operating parameters comprises the processing circuitry configured to cause the memory system to:
adjust a rate of a clock associated with the memory system, a pattern of the clock associated with the memory system, or both, in response to determining that the current received by the current sensor satisfies the threshold value.

7. The memory system of claim 1, wherein the processing circuitry is further configured to cause the memory system to:
generate one or more power profiles associated with the memory system in response to determining that the current received by the current sensor satisfies the threshold value and in response to adjusting the one or more operating parameters.

8. The memory system of claim 1, wherein adjusting the one or more operating parameters comprises the processing circuitry configured to cause the memory system to:
apply a delay to one or more commands received by the memory system in response to determining that the current received by the current sensor satisfies the threshold value.

9. The memory system of claim 1, wherein the processing circuitry is further configured to cause the memory system to:
output a flag in response to determining that the current received by the current sensor satisfies the threshold value, wherein adjusting the one or more operating parameters is in response to outputting the flag.

10. An application-specific integrated circuit (ASIC), comprising:
an alternating current voltage source associated with powering one or more components of the ASIC;
a current mirror coupled with the alternating current voltage source;
a current sensor configured to receive a current from the current mirror; and
logic coupled with the current sensor and configured to:
determine whether the current received by the current sensor satisfies a threshold value; and
adjust one or more operating parameters associated with the ASIC in response to determining that the current received by the current sensor satisfies the threshold value.

11. The ASIC of claim 10, further comprising:
a direct current voltage source associated with powering one or more second components of the ASIC; and
an interface, wherein the logic is further configured to:
generate a first token in accordance with first current information associated with the direct current voltage source; and
generate a second token in accordance with second current information associated with the interface, wherein adjusting the one or more operating parameters associated with the ASIC is in response to generating the first token and the second token.

12. The ASIC of claim 11, wherein the logic is further configured to:
generate a third token in accordance with the current received by the current sensor; and
determine whether one or more of the first token, the second token, and the third token satisfies a second threshold value, wherein adjusting the one or more operating parameters associated with the ASIC is in response to determining that one or more of the first token, the second token, and the third token satisfies the second threshold value.

13. The ASIC of claim 11, wherein the first token is associated with an M-PHY interface powered by the direct current voltage source, one or more logic gates powered by the direct current voltage source, and a phase locked loop powered by the direct current voltage source.

14. The ASIC of claim 11, wherein the second token is associated with one or more controllers associated with the interface, one or more channels associated with the interface, and one or more memory devices associated with the interface.

15. The ASIC of claim 10, wherein the logic is further configured to:
adjust a rate of a clock associated with the ASIC, a pattern of the clock associated with the ASIC, or both, in response to determining that the current received by the current sensor satisfies the threshold value.

16. The ASIC of claim 10, wherein the logic is further configured to:
generate one or more power profiles associated with the ASIC in response to determining whether the current received by the current sensor satisfies the threshold value and in response to adjusting the one or more operating parameters.

17. The ASIC of claim 10, wherein the logic is further configured to:
apply a delay to one or more commands received by an interface of the ASIC in response to determining that the current received by the current sensor satisfies the threshold value.

18. The ASIC of claim 10, wherein the logic is further configured to:
output a flag in response to determining that the current received by the current sensor satisfies the threshold value.

19. A non-transitory computer-readable medium storing code comprising instructions which, when executed by processing circuitry of a memory system, cause the memory system to:
receive, by a current sensor, a current from a current mirror coupled with an alternating current voltage source, wherein the alternating current voltage source is associated with powering a set of components of the memory system;
determine whether the current received by the current sensor satisfies a threshold value; and
adjust one or more operating parameters of the memory system in response to determining that the current received by the current sensor satisfies the threshold value.

20. The non-transitory computer-readable medium of claim 19, wherein the instructions, when executed by the processing circuitry of the memory system, further cause the memory system to:
generate a first token in accordance with first current information associated with a direct current voltage source, wherein the direct current voltage source is associated with powering a second set of components of the memory system; and
generate a second token in accordance with second current information associated with an interface of the memory system, wherein adjusting the one or more operating parameters associated with the memory system is in response to generating the first token and the second token.

21. The non-transitory computer-readable medium of claim 20, wherein the instructions, when executed by the processing circuitry of the memory system, further cause the memory system to:
generate a third token in accordance with the current received by the current sensor; and
determine whether one or more of the first token, the second token, and the third token satisfies a second threshold value, wherein adjusting the one or more operating parameters associated with the memory system is in response to determining that one or more of the first token, the second token, and the third token satisfies the second threshold value.

22. The non-transitory computer-readable medium of claim 20, wherein the first token is associated with an M-PHY interface powered by the direct current voltage source, one or more logic gates powered by the direct current voltage source, and a phase locked loop powered by the direct current voltage source.

23. The non-transitory computer-readable medium of claim 20, wherein the second token is associated with one or more controllers associated with the interface, one or more channels associated with the interface, and one or more memory devices associated with the interface.

24. The non-transitory computer-readable medium of claim 19, wherein the instructions, when executed by the processing circuitry of the memory system, further cause the memory system to:
adjust a rate of a clock associated with the memory system, a pattern of the clock associated with the memory system, or both, in response to determining that the current received by the current sensor satisfies the threshold value.

25. The non-transitory computer-readable medium of claim 19, wherein the instructions, when executed by the processing circuitry of the memory system, further cause the memory system to:
generate one or more power profiles associated with the memory system in response to determining that the current received by the current sensor satisfies the threshold value and in response to adjusting the one or more operating parameters.
